(19) United States
(12) Patent Application Publication
(10) Pub. No.: US 2016/0239083 A1
(43) Pub. Date: Aug. 18, 2016

(54) Jewelry-Stylus Device

(71) Applicant: Peter Shu-Chun CHENG, Hong Kong (CN)

(72) Inventor: Peter Shu-Chun CHENG, Hong Kong (CN)

(21) Appl. No.: 14/624,791

(22) Filed: Feb. 18, 2015

(51) Int. Cl. G06F 3/01; G06F 3/033

(52) U.S. Cl. CPC G06F 3/014; G06F 3/033; G06F 2203/0331

(57) ABSTRACT

A jewelry-stylus device includes a jewelry item wearable on a body part of a user, and a stylus element mounted on the jewelry item, for contacting a touch screen. The device may have a plurality of arcuate shank parts that are movable between a closed position in which the shank parts form an annulus that at least partially encircles a body part of the user, and an open position in which two of the shank parts are connected in series along a row when the device is used as a stylus, for example, for data entry. The stylus element, for example, an electrically conductive nib, is mounted on one of the shank parts and positioned at a leading end nib region of the stylus in the open position. The user grips the device at another shank part remotely from the nib.

### FIELD OF THE INVENTION

The present invention generally relates to a jewelry item wearable on a body part of a user, and having a stylus element for contacting a touch screen, and, more particularly, to a device that is readily convertible between the jewelry item and a touch screen stylus.

### DESCRIPTION OF THE RELATED ART

The present invention generally relates to a device or tool for use with touch-sensitive electronic screens such as those found in computers, smartphones, tablets, media readers and players, cameras, appliances and like electronic equipment requiring data entry via a touch screen. Typically, a smooth-tipped, wide-barreled stylus is designed to be held in a user's hand as one would hold a pen or pencil, and is brought into contact with the touch screen. The stylus allows the user to accurately point to, and contact, the touch screen at precise locations, as well as to write individual letters and numbers into input fields displayed on the touch screen, and even to sketch and draw graphical representations on the touch screen, without the use of a pen, pencil, brush, or other type of marking instrument. As advantageous as the stylus is, however, a wide barrel tends to at least partially obscure adjacent locations on the touch screen from being seen by the user. Moreover, the user's hand tends to grip the stylus adjacent its nib, thereby also resulting in concealing adjacent locations on the touch screen since the user's hand itself is positioned close to, and at least partially overlies, the touch screen. Such concealment reduces stylus performance.

Such equipment is typically designed to include a holder for the stylus. However, sometimes, there is insufficient space in the equipment to accommodate a holder and, in any event, the stylus is subject to being lost, e.g., when the user forgets to replace it in the holder, and a replacement stylus must be obtained. To avoid the need for a stylus and its holder, the art has resorted, especially in the field of tablets and smartphones, to simply use one's forefinger to contact the touch screen. Using one's forefinger as a stylus replacement is advantageous, but the inevitable oil and grease on one's forefinger eventually contaminate the touch screen with unsightly smudges and streaks, which require frequent cleaning. Also, the use of one's forefinger unavoidably positions the user's hand close to the screen, thereby causing the user's other fingers and the back of the user's hand to conceal adjacent locations on the touch screen. Again, stylus performance is reduced by such concealment.

Accordingly, it would be desirable to use a stylus that not only is compact, inexpensive, comfortable, easy to use, does not obscure adjacent touch screen locations during use, and is an attractive gift item and conversation piece, but also eliminates the requirement for the equipment to accommodate a stylus holder, while still preventing the stylus from being lost. It would further be desirable not to have to constantly clean a touch screen contaminated by one's finger during use.

### SUMMARY OF THE INVENTION

According to one aspect of this invention, a jewelry-stylus device includes a jewelry item wearable on a body part of a user, and a stylus element mounted on the jewelry item, for contacting a touch screen during use as a stylus. Advantageously, the stylus element is replaceably mounted on the jewelry item so that a worn stylus element can be readily replaced with a new stylus element.

In one embodiment, the device is convertible between the item of jewelry worn by the user, and a touch screen stylus held by the user's hand. Advantageously, the device has a plurality of arcuate shank parts movable between a closed position and an open position. In the closed position, the shank parts form an annulus that at least partially, and preferably completely, circumferentially encircles a body part of the user. For example, the body part may be a finger, in which case, the annulus surrounds the user's finger to form a ring. As another example, the body part may be a wrist, in which case, the annulus surrounds the user's wrist to form a bracelet. In the open position, two of the shank parts are connected in series along a row to form the stylus. The stylus element, preferably an electrically conductive nib, is mounted on one of the shank parts, preferably by being detachably fitted thereon, and is positioned at a leading end nib region of the stylus in the open position. The user's hand preferably grips the stylus remotely from the nib at the other of the shank parts to avoid having the hand from overlying, and at least partially concealing, adjacent touch screen locations.

In accordance with this invention, when the device is not being used as a stylus for contacting a touch screen of electronic equipment, the device is readily available because it is being worn, for example, as a ring on the user's finger, or as a bracelet on the user's wrist, and is therefore conveniently accessible. No longer need the equipment have to accommodate a holder for the stylus. The stylus is less prone to being lost by forgetting to replace it in any holder. Instead, the device is readily converted to a ring or bracelet and placed on one's finger or wrist, to await a subsequent use. No longer is the touch screen contaminated by oil and grease and like contaminants.

In preferred embodiments, the two shank parts are pivotably connected in end-to-end relationship for pivoting movement between the closed and open positions about a pivot axis. The two shank parts are advantageously mirror symmetrical. At least one, and preferably both, of the two shank parts have abutments for abutting the shank parts against one another to prevent movement past the open position. At least one, and preferably both, of the two shank parts have locks for adjustably locking the shank parts to one another in the closed position. An arcuate retainer preferably extends across opposite end regions of the other of the shank parts to retain the device on the finger or wrist in the open position.

In another embodiment, the device need not be removed from the user's body part for use as a stylus. Thus, one or more stylus elements are positioned away from the shank parts so that the device may be used as a stylus even while being worn on the user's body part.

According to another aspect of this invention, a method of converting a device between an item of jewelry and a stylus, is performed by connecting a plurality of arcuate shank parts for movement relative to one another, mounting a stylus element on one of the shank parts, moving the shank parts to a closed position in which the shank parts form an annulus that at least partially encircles a body part of the user, and moving the shank parts to an open position in which two of the shank parts are connected in series along a row when the device is held by the user's hand as a stylus, and positioning the stylus element at a leading end nib region of the stylus in the open position.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of one embodiment of a device converted to, and worn as, a ring in a closed position according to a first embodiment of the present invention.

FIG. 2 is a perspective view of the device of FIG. 1 converted to, and used as, a stylus in an open position according to the first embodiment of the present invention.

FIG. 3 is an enlarged, perspective view of the device of FIG. 2 in isolation in the open position.

FIG. 4 is an enlarged, perspective view of a second embodiment of a device in the open position according to the present invention.

FIG. 5 is an enlarged, exploded view of a third embodiment of a device in the closed position according to the present invention.

FIG. 6 is a side view of the device of FIG. 5 in the open position.

FIG. 7 is a side view of a fourth embodiment of a device depicting the open position in solid lines, and the closed position in phantom lines, according to the present invention.

FIG. 8 is a side view of a fifth embodiment of a device in the open position according to the present invention.

FIG. 9 is a side view of a sixth embodiment of a device in the open position according to the present invention.

FIG. 10 is an exploded, perspective view of a seventh embodiment of a device in the open position according to the present invention.

FIG. 11 is a perspective view of an eighth embodiment of a device in the closed position according to the present invention.

FIG. 12 is an enlarged, sectional view taken on line 12-12 of FIG. 11.

FIG. 13 is a perspective view of the eighth embodiment of FIG. 11 in the open position according to the present invention.

FIG. 14 is a perspective view of the eighth embodiment of FIG. 11 worn on a user's thumb.

FIG. 15 is a top plan view of a ninth embodiment of a device worn on a user's finger according to the present invention.

FIG. 16 is a side view of the ninth embodiment of FIG. 15.

FIG. 17 is a perspective view of the ninth embodiment of FIG. 15 during use as a stylus.

### DETAILED DESCRIPTION OF THE PREFERRED EMBODIMENTS

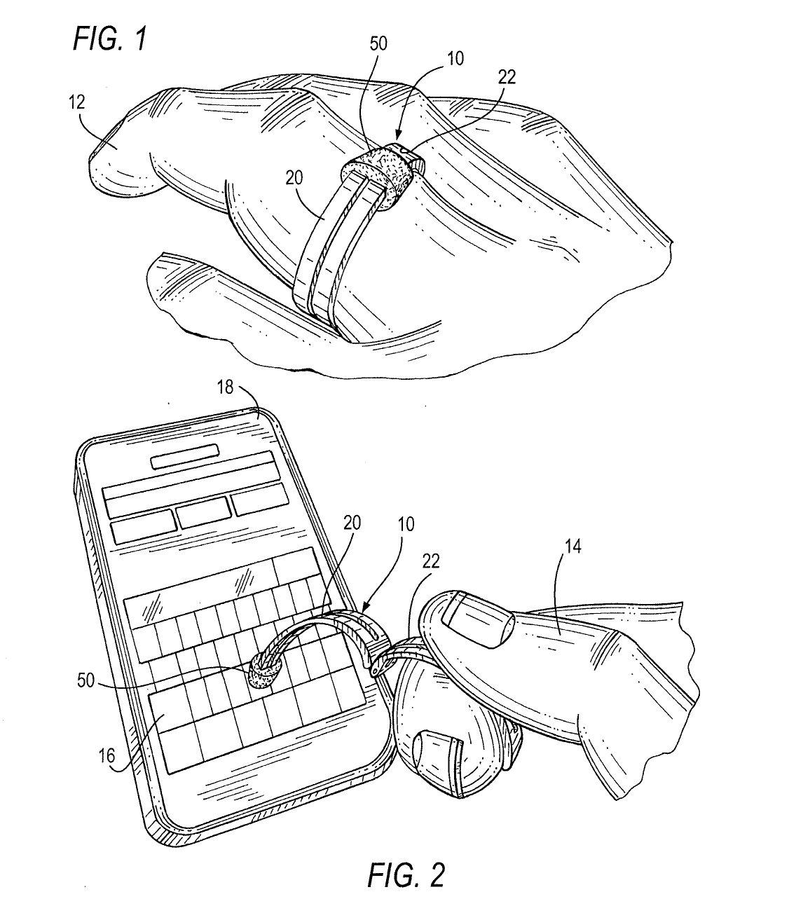

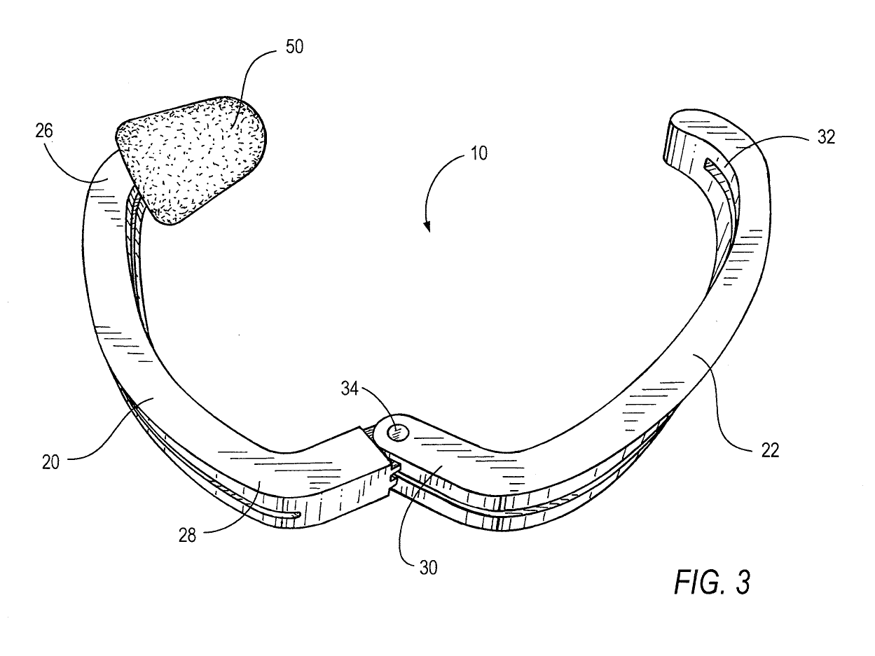

Referring to FIGS. 1-3 of the drawings, a jewelry-stylus device 10, according to one embodiment of this invention, is convertible between an item of jewelry, such as a ring, as best seen in FIG. 1, worn on a user's finger 12, and a touch screen stylus, as best seen in FIG. 2, held by the user's hand 14 for contacting a touch screen 16 of an item of electronic equipment 18, e.g., a smartphone. As best seen in FIG. 3, the device 10 has a plurality of shank parts 20, 22 movable between a closed position (FIG. 1) and an open position (FIG. 2). In the closed position, the shank parts 20, 22 form an annulus that at least partially, and preferably completely, circumferentially encircles the user's finger 12 to form the ring. In the open position, two of the shank parts 20, 22 are connected in series along a row in an end-to-end relationship to form the stylus.

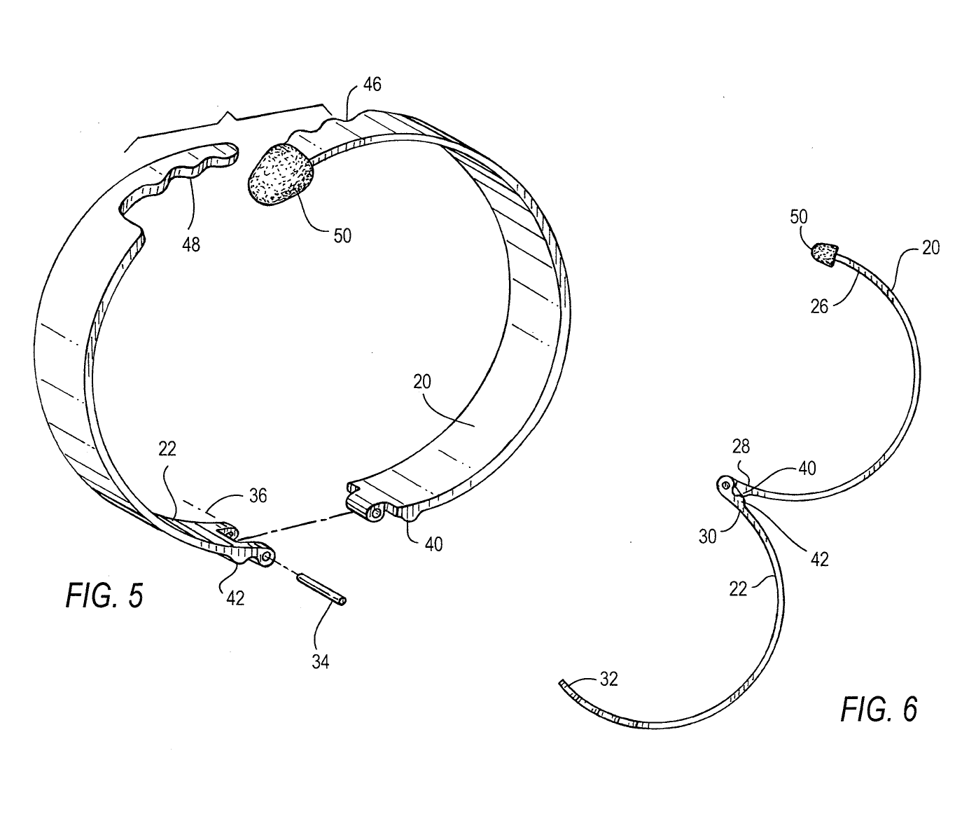

Preferably, each shank part 20, 22 includes one or more generally semi-circular, C-shaped, flattened, strips or curved bands made of metal or plastic, advantageously of resilient material. A precious metal, such as gold, can be used, especially when the device is intended as a gift item. Shank part 20 has opposite end regions 26, 28. Shank part 22 has opposite end regions 30, 32. The two shank parts 20, 22 are pivotably interconnected by a hinge pin 34 extending through the end regions 28, 30 to enable the shank parts 20, 22 to pivot relative to each other between the closed and open positions about a pivot axis 36 (see FIG. 5) along which the hinge pin 34 extends. The two shank parts 20, 22 are advantageously mirror symmetrical.

A touch screen or stylus element 50, preferably an electrically conductive nib, is mounted on one of the shank parts, and is positioned at end region 26, preferably by being replaceably fitted thereover. The stylus element 50 is configured with a generally conically, cupped shape that resembles a thimble, is press-fitted over the end region 26, and is preferably maintained in position by friction. Advantageously, the stylus element 50 is replaceably mounted on the device 10 so that a worn stylus element 50 can be readily replaced with a new stylus element 50. For a more secure anchoring, an adhesive can be employed. In the open position, the element 50 serves as the nib of the stylus. The touch element 50 is advantageously constituted of rubber impregnated with carbon or metal filaments, but other electrically conductive materials, such as a high density foam, could also be used. The stylus can be a capacitive, a resistive, an inductive, or a pressure-sensitive, stylus.

In accordance with this invention, when the device 10 is not being used as a stylus for contacting the touch screen 16 of the electronic equipment 18, the device 10 is readily available because it is being worn as a ring on the user's finger 12 (see FIG. 1) and is therefore conveniently accessible. No longer need the equipment 18 have to accommodate a holder for the stylus. The stylus is less prone to being lost by forgetting to replace it in any holder. Instead, the device 10 is converted to a ring and placed on one's finger, to await a subsequent use. No longer is the touch screen 16 contaminated by oil and grease and like contaminants.

Moreover, as best shown in FIG. 2, the user's hand 14 preferably grips the stylus remotely from the nib 50 at the other of the shank parts 22 to avoid having the hand 14 from overlying, and at least partially concealing, adjacent touch screen locations. The hand 14 is therefore deliberately positioned well away from the nib 50. Friction between the hinge pin 34 and the shank parts 20, 22 is sufficient to ensure that the shank parts 20, 22 do not collapse and return to the closed position when the stylus is pressed against the touch screen.

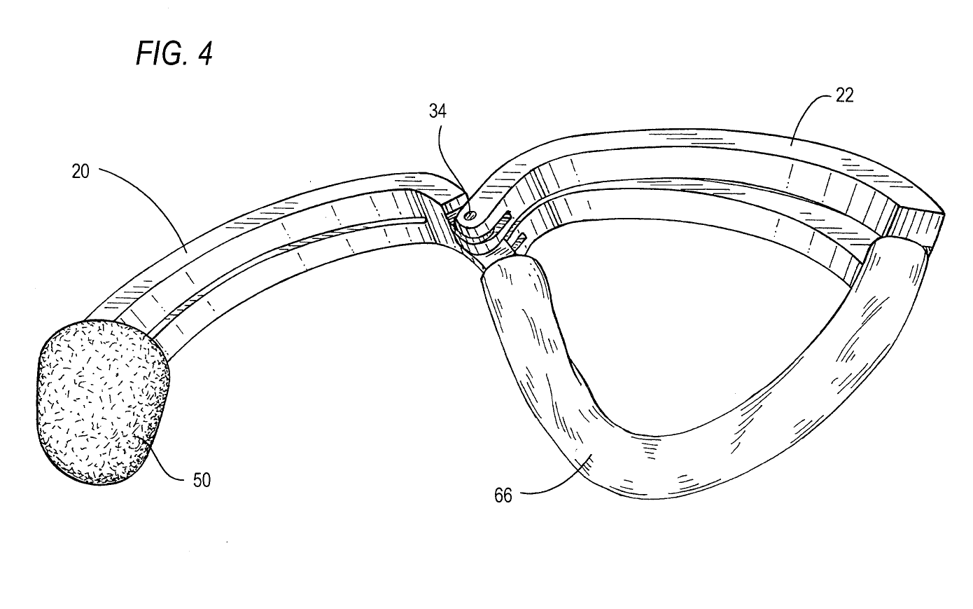

Additional embodiments of the convertible device are illustrated in FIGS. 4-14. The embodiment of FIG. 4 is identical to that shown in FIG. 3, except that, in addition, an arcuate retainer 66, preferably configured as a coiled tube or spring, extends across opposite end regions of the shank part 22 to retain the device 10 on the finger in the open position.

In the embodiment of FIGS. 5-6, at least one, and preferably both, of the two shank parts 20, 22 have abutments 40, 42 for abutting the shank parts against one another to prevent movement past the open position. In the open position, the two semi-circular shank parts 20, 22 are situated adjacent each other and generally resemble the letter “m”. At least one, and preferably both, of the two shank parts 20, 22 have self-locking jaws or locks 46, 48 at the end regions 26, 32 for locking the shank parts 20, 22 to one another in the closed position. Each lock 46, 48 has a series of teeth for adjustably engaging one another to a desired extent, thereby controlling the diameter of the annulus in the closed position to accommodate fingers of different sizes.

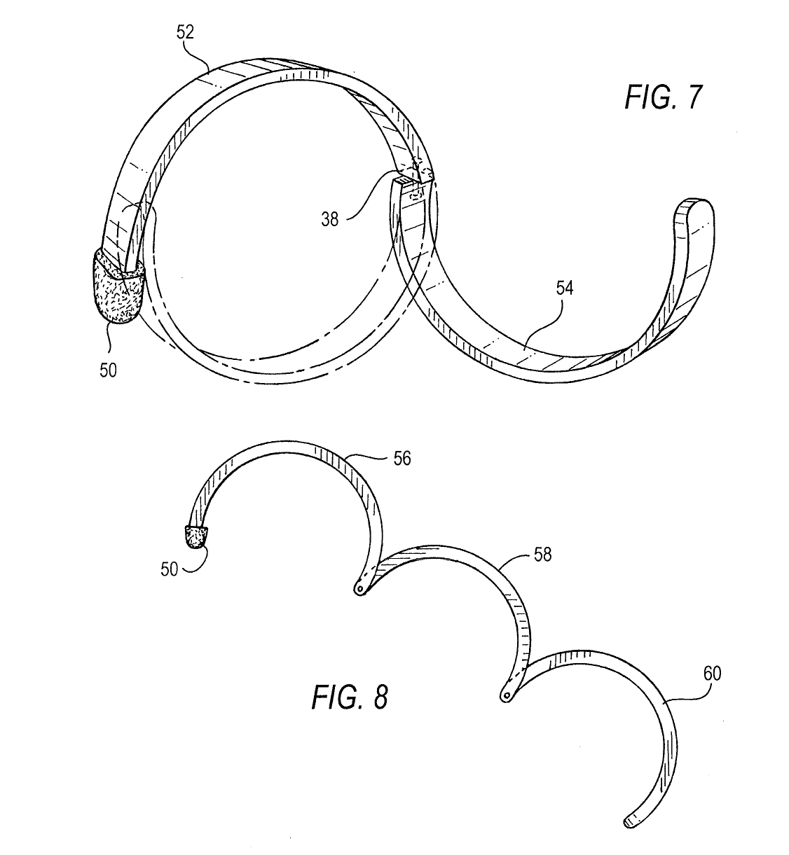

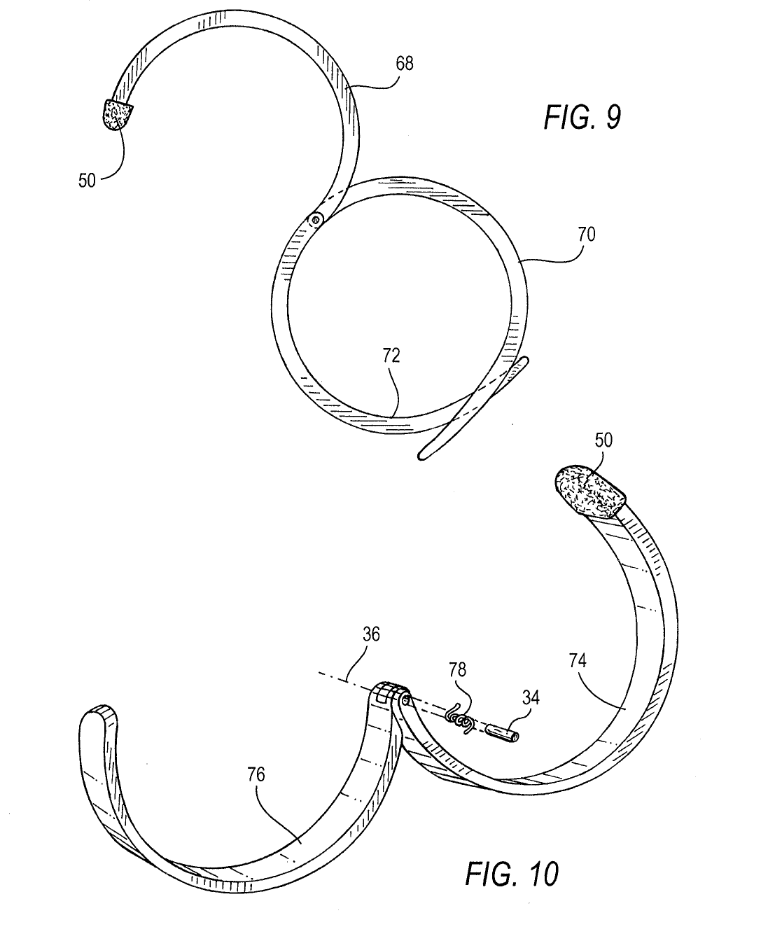

In the embodiment of FIG. 7, the two shank parts 52, 54 are not interconnected by a hinge pin 34, but instead, are interconnected by a swivel joint 38 that enables swiveling movement so that in the illustrated open position, the shank parts 52, 54 generally resemble a reversed letter “s”. In the embodiment of FIG. 8, there are three shank parts 56, 58, and 60 arranged in a row. In the embodiment of FIG. 9, the two shank parts 68, 70 are pivotably interconnected just like the shank parts 20, 22, but, in addition, another shank part 72 extends across opposite end regions of the shank part 70 to retain the device 10 on the finger in the open position. In the embodiment of FIG. 10, the two shank parts 74, 76 are pivotably interconnected just like the shank parts 20, 22, but, in addition, a coil spring 78 surrounds the hinge pin 34 and is tensioned to constantly urge the shank parts 74, 76 to the illustrated open position. The coil spring 78 serves as a spring-assist to insure that the shank parts 74, 76 are automatically moved to their fully open position.

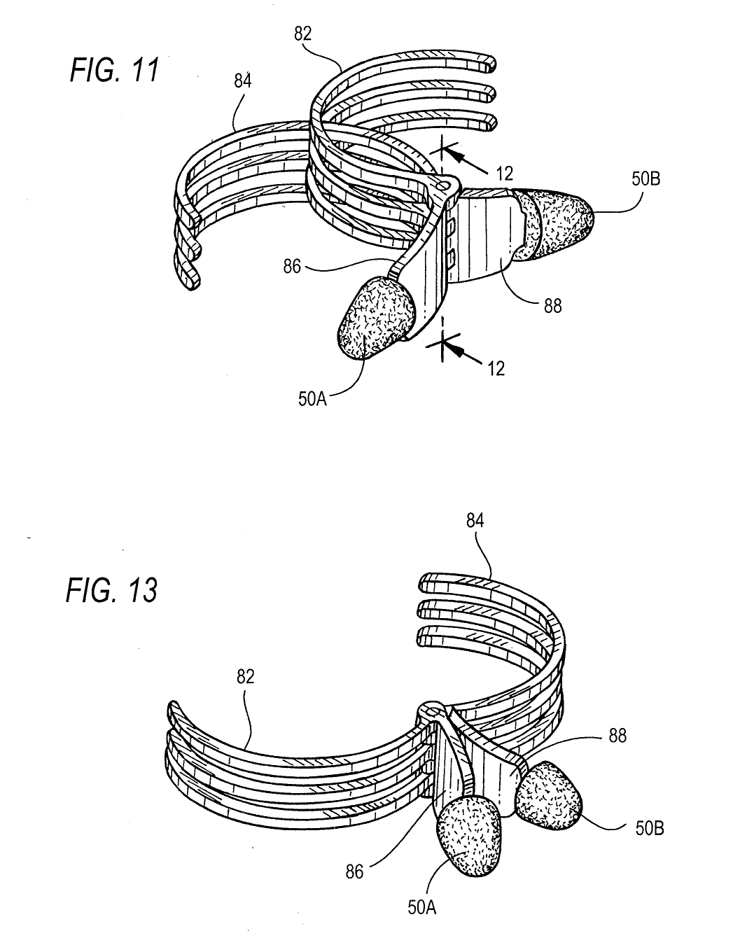

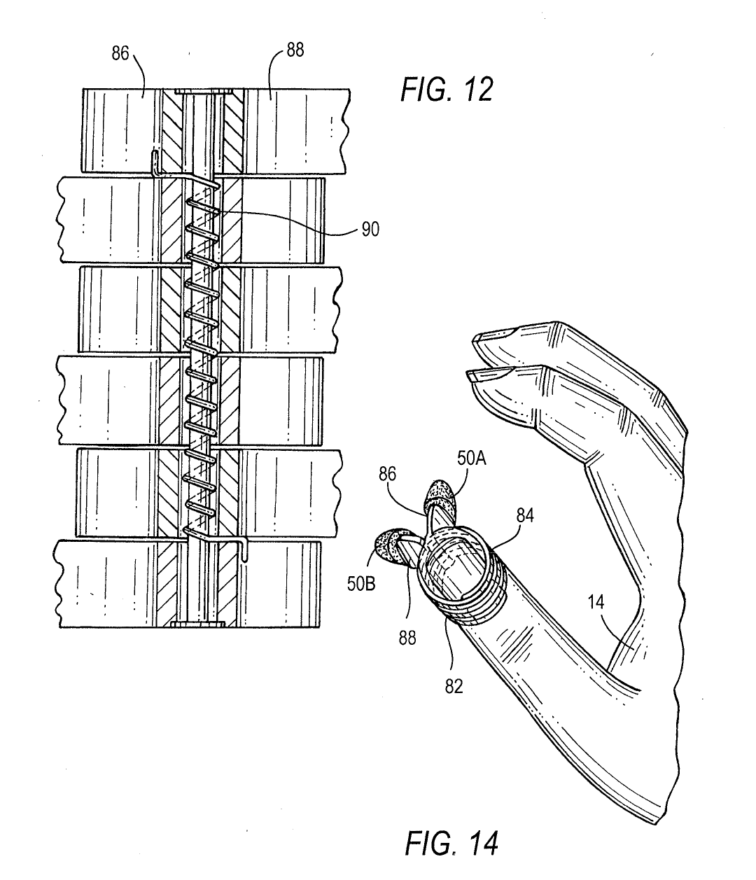

In the embodiment of FIGS. 11-14, the shank parts 82, 84 are each comprised of a plurality of C-shaped, curved, elongated teeth or prongs that cross and interlace with one another in the fully closed position of FIG. 11, and that are spaced apart in the fully open position of FIG. 12. To effect movement from the closed to the open position, the shank parts 82, 84 have handle extensions 86, 88 that are squeezed together against the restoring force of a coil spring 90 (see FIG. 12). Stylus elements 50A, SOB, each identical to the element 50 described above, are replaceably mounted on remote ends of the handle extensions 86, 88. When the embodiment of FIGS. 11-14 is worn and used as a stylus, the prongs firmly grip the user's body part to resist rotation of the shank parts 82, 84 relative to the user's body part.

In the embodiment of FIGS. 11-14, the device is, as depicted in FIG. 14, worn as a ring on a body part of the user, e.g., on the thumb of the user's hand 14 and, at the same time, the device serves as a stylus in which either or both of the stylus elements 50A, 50B may be used to contact a touch screen. In the embodiment of FIGS. 11-14, the device need not be removed from the user's thumb, nor does the device need to be converted since it simultaneously serves both as a ring and as a stylus. The device need not be worn on the thumb, but can be moved to other fingers of the user's hand. The coil spring 90 constantly urges the device towards the closed position and can therefore accommodate thumbs and fingers of different sizes.

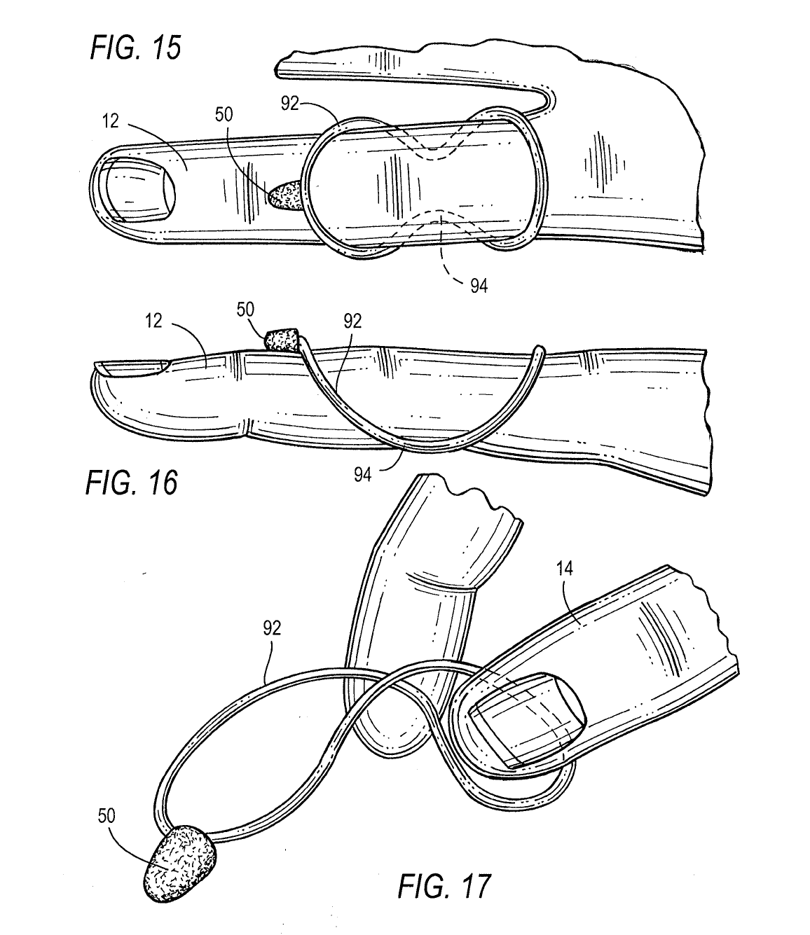

In the embodiment of FIGS. 15-17, there are no movable shank parts as described above, but instead, a wire frame 92 is mounted on the user's finger 12, as shown in FIGS. 15-16, and is removed from the user's finger 12 and held in the user's hand 14, as shown in FIG. 17, for use as a stylus. The aforementioned stylus element 50 is mounted at a forward region on the wire frame 92. The user's finger 12 extends through open opposite ends of the wire frame 92, and is held on the finger from above by the opposite ends of the wire frame 92, and is held on the finger from below by a constricted waist 94 located below the finger.

It will be understood that each of the elements described above, or two or more together, also may find a useful application in other types of constructions differing from the types described above. For example, the shank parts may be provided with friction-enhancements or waved ridges to enable a firmer stylus grip. A spring assist may be used to facilitate the movement between the closed and open positions. The element 50 need not be a cup fitted over an end region of the shank part 20, but could be molded thereon.

While the invention has been illustrated and described as a convertible ring-stylus device, it is not intended to be limited to the details shown, since various modifications and structural changes may be made without departing in any way from the spirit of the present invention. For example, the device need not be a ring worn on the user's finger, but could be a bracelet or wristwatch worn on the user's wrist. The device could also be other wearable items of jewelry, such as an earring worn on the user's ear.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

I claim:

1. A jewelry-stylus device, comprising:
a jewelry item wearable on a body part of a user; and
a stylus element mounted on the jewelry item, for contacting a touch screen.

2. The jewelry-stylus device of claim 1, wherein the item comprises a plurality of arcuate shank parts movable to a closed position in which the shank parts form an annulus that at least partially encircles the body part of the user, and wherein the stylus element is mounted on one of the shank parts.

3. The jewelry-stylus device of claim 2, wherein the shank parts are movable to an open position in which two of the shank parts are connected in series along a row when the device is used as a stylus, and wherein the stylus element is positioned at a leading end nib region of the stylus in the open position.

4. The jewelry-stylus device of claim 3, wherein the two shank parts are pivotably connected for pivoting movement between the closed and open positions about a pivot axis, and a tensioned member for constantly urging the two shank parts toward the open position.

5. The jewelry-stylus device of claim 3, wherein at least one of the two shank parts has an abutment for abutting against another of the shank parts to prevent movement past the open position.

6. The jewelry-stylus device of claim 2, wherein at least one of the two shank parts has a lock for adjustably locking with another of the shank parts in the closed position.

7. The jewelry-stylus device of claim 3, and an arcuate retainer extending across opposite end regions of another of the shank parts to retain the device on the body part in the open position.

8. The jewelry-stylus device of claim 1, wherein the stylus element is an electrically conductive nib that is replaceably mounted on the jewelry item.

9. The jewelry-stylus device of claim 2, wherein the shank parts have elongated extensions that extend away from the jewelry item, and wherein the stylus element is mounted on a remote end of at least one of the extensions.

10. The jewelry-stylus device of claim 9, wherein each shank part has a plurality of prongs that firmly engage the user's body part to resist rotation relative to the user's body part.

11. The jewelry-stylus device of claim 1, wherein the item comprises a wire frame.

12. A method of converting a device between an item of jewelry and a stylus, comprising the steps of:
connecting a plurality of arcuate shank parts for movement relative to one another;
mounting a stylus element on one of the shank parts;
moving the shank parts to a closed position in which the shank parts form an annulus that at least partially encircles a body part of a user; and
moving the shank parts to an open position in which two of the shank parts are connected in series along a row when the device is held by the user's hand as a stylus, and positioning the stylus element at a leading end nib region of the stylus in the open position.

13. The method of claim 12, wherein the connecting step is performed by pivotably connecting the two shank parts for pivoting movement between the closed and open positions about a pivot axis.

14. The method of claim 12, and constantly urging the two shank parts toward the open position.

15. The method of claim 12, wherein the connecting step is performed by pivotably connecting an opposite end region of the one shank part to an end region of another of the shank parts.

16. The method of claim 12, and abutting the two shank parts against one another to prevent movement past the open position.

17. The method of claim 12, and adjustably locking the two shank parts together in the closed position.

18. The method of claim 12, and constituting the touch screen element as an electrically conductive nib.

19. The method of claim 12, and replacably fitting the touch screen element over an end region of the one shank part.

20. The method of claim 12, and gripping another of the shank parts as a handle in the open position remotely from the touch screen element.
